(19) United States
(12) Patent Application Publication
(10) Pub. No.: US 2025/0347317 A1
(43) Pub. Date: Nov. 13, 2025

(54) Roller Bearing Comprising a Multi-Component Plastics Bearing Ring

(71) Applicant: igus GmbH, Köln (DE)

(72) Inventors: Lena Wölke-Glomb, Lohmar (DE); Marcus Semsroth, Remagen (DE); Gerhard Baus, Unkel (DE)

(73) Assignee: igus GmbH, Kain (DE)

(21) Appl. No.: 18/868,957

(22) PCT Filed: May 25, 2022
(86) PCT No.: PCT/EP2022/064348

§ 371 Date: Nov. 25, 2024

(51) Int. Cl. F16C 19/06; F16C 33/30; F16C 33/32; F16C 33/58

(52) U.S. Cl. CPC F16C 19/06; F16C 33/303; F16C 33/32; F16C 33/585; F16C 2326/28

(57) ABSTRACT

A rolling bearing, in particular a ball bearing, is in the form of two bearing rings that are mounted so as to be rotatable relative to each other about an axis. The roller bearing includes an inner ring and an outer ring which each form a guide portion of a guide. The guide portion surrounds the axis with the portion formed by the inner ring is radially opposite the portion formed by the outer ring. In the guide, rolling bodies are distributed around the axis and rest on the two guide portions. When the bearing rings rotate, the rolling bodies roll on the two guide portions. At least one of the rings has a slide ring as the guide portion and a stabilising ring on the slide ring. The slide ring and the stabilising ring are produced from first and second plastics materials, respectively. The first plastics material is softer than the second plastics material.

The invention relates to a rolling bearing according to the preamble of claim 1 and to a device which comprises such a rolling bearing as well as an outer and an inner component, wherein the two components are mounted so as to be rotatable relative to each other and are connected to each other by the rolling bearing.

Generic rolling bearings are well known in the prior art. Such rolling bearings have two bearing rings, namely an inner ring and an outer ring. The inner ring is surrounded by the outer ring at least in portions and is radially spaced from it at least in portions, wherein rolling bodies are provided between the inner ring and the outer ring, which are configured to roll on both bearing rings while they are in contact with the two bearing rings. As a result, the bearing rings are mounted so as to be rotatable relative to each other about an axis of the rolling bearing, wherein such rolling bearings may absorb a not inconsiderable radial force due to the provision of the rolling bodies. In widespread embodiments, such rolling bearings are configured as ball bearings in which balls are provided as rolling bodies. The invention relates in particular to such ball bearings. Furthermore, in preferred embodiments, rolling bearings are configured as deep groove ball bearings, in which the inner ring and the outer ring together form a groove-like guide for the balls, in which the balls are guided between the bearing rings, whereby these deep groove ball bearings may also absorb a certain axial force. The invention relates in particular to such deep groove ball bearings. In general, it should be noted that the suitability of a rolling bearing for absorbing a force is based on a force acting relatively between the inner ring and the outer ring of the rolling bearing. It should also be generally noted that the term “axial” refers to a direction along the axis of the rolling bearing about which the bearing rings are mounted so as to be rotatable relative to each other, and that the term “radial” refers to a direction perpendicular to this axis.

In generic rolling bearings, the bearing rings therefore each have a guide portion of the guide, which is formed between the bearing rings and in which the rolling bodies are mounted between the bearing rings. The guide portions of the bearing rings are thus radially opposite each other and the rolling bodies are arranged radially between them. The guide portions are each configured to surround the axis in a closed manner. The balls are distributed in the guide around the axis, in particular evenly distributed, and are arranged in contact with both guide portions in the guide so that the rolling bodies roll on both guide portions when the bearing rings rotate relative to each other around the axis. In principle, such a rolling bearing may reliably ensure a low-friction bearing arrangement of the two bearing rings rotatable around the axis, wherein the bearing rings are reliably positioned in relation to each other both axially and radially. However, various difficulties arise with such rolling bearings. For example, conventional rolling bearings require considerable lubrication of the rolling bodies in the guide in order to enable long-term reliable function, and if the interference fit of the rolling bearings between the bearing rings is too strong, the friction is increased too much, which is associated with wear and, at a considerable speed, with heating, and if the interference fit is too low, there is a risk of play between the bearing rings. In addition, the choice of material for the production of such rolling bearings is difficult. On the one hand, sufficient stability of the bearing rings must be ensured, on the other hand, the lowest possible friction between rolling bodies and bearing rings should be realised and, in addition, the rolling bearings should ideally be suitable for both low and high rotational speeds of the bearing rings in relation to each other around the axis, and since such rolling bearings are used on a large scale to support a wide variety of components in relation to each other, the bearing rings and the rolling bearing as a whole should also be as cost-effective as possible.

Rolling bearings according to the prior art are known, for example, from the documents U.S. Pat. No. 4,892,421 A, GB 940 010 A, DE 10 2015 200 376 A1, DE 10 2018 124 335 A1, U.S. Pat. No. 7,422,372 B2, WO 2013017157 A1, JP 2016 080122 A and EP 3 287 298 B1.

The object of the present invention is that of providing a rolling bearing or a device comprising a rolling bearing which at least partially remedies at least one disadvantage or problem which occurs in generic rolling bearings or devices.

As a solution to the problem forming the basis of the invention, the invention proposes a rolling bearing having the features according to claim 1.

The rolling bearing comprises an inner ring and an outer ring as two bearing rings of the rolling bearing that are mounted so as to be rotatable relative to each other about an axis. The inner ring and the outer ring each form a guide portion that surrounds the axis, in particular a guide portion that surrounds the axis in an uninterrupted closed manner, of a guide provided between the bearing rings. The guide portion formed by the inner ring is radially opposite the guide portion formed by the outer ring. The guide portions may be formed by sides of the inner ring and the outer ring pointing radially towards each other. In the guide, rolling bodies are distributed around the axis and arranged in a manner resting on both guide portions. Preferably, the rolling bodies are fixed both in their axial position and in their radial distance from the axis by their contact with the two guide portions. When the bearing rings rotate relative to each other about the axis, the rolling bodies roll on both guide portions. Due to the rolling bodies rolling on the guide portions, the bearing rings are rotatably mounted in relation to each other by means of the rolling bodies. Preferably, the rolling bodies are evenly distributed around the axis so that the same spacing angle around the axis is always provided between two adjacent rolling bodies in the direction of rotation around the axis. The rolling bearing is preferably configured as a ball bearing, wherein the rolling bodies are configured as balls. In other embodiments, rolling bodies other than balls may also be provided, for example cylinders. According to the invention, at least one of the bearing rings has a slide ring, which forms the guide portion of the bearing ring, and a stabilising ring, which rests on the slide ring so as to surround the axis, wherein the slide ring is produced from a first plastics material and the stabilising ring is produced from a second plastics material. The first and second plastics materials differ from each other, wherein the first plastics material is softer than the second plastics material. In embodiments, the rolling bearing according to the invention may have features which are disclosed without a connection to generic rolling bearings.

The configuration of the rolling bearing according to the invention has particular advantages. By making the first plastics material, from which the slide was made, softer than the second plastics material, from which the stabilising ring is produced, the first plastics material may be specifically configured to be as optimised as possible for low-friction and low-noise interaction with the rolling bodies without compromising the overall stability of the bearing ring, since the stabilising ring ensures sufficient stabilisation of the bearing ring due to its hardness and associated strength. The first plastics material is particularly preferably a sliding material. Sliding materials are well known as plastics materials with good sliding properties. A tribological polymer is particularly preferred as a sliding material, i.e., a polymer plastic that is tribologically optimised, i.e., has good friction and/or lubrication properties. Such a polymer plastic is also referred to as a tribopolymer. Such a sliding material is particularly suitable for processing by injection moulding. A tribopolymer may, for example, be a thermoplastic tribopolymer or a thermoset tribopolymer. The tribopolymer typically contains one or more base polymers and additives, wherein the additives may be provided specifically to optimise wear or friction reduction. For example, lubricants, such as finely divided solid lubricants, for example molybdenum disulfide or graphite, may be provided as additives. In one embodiment, the tribopolymer contains further additives, for example for stabilisation purposes, such as fillers, in particular plastics material or textile fibres or particles. Examples of base polymers are polyethylene (PE), polypropylene (PP), polyacetal (POM), polycarbonate (PC), polyamide (PA, PA6, PA12, PA46, PA66), polyvinyl chloride (PVC) and polytetrafluoroethylene (PTFE), polyketone (PK), acrylonitrile butadiene styrene (ABS), for special applications, for example in the food industry and/or for good resistance at high temperatures, for example polyetherketone (PEK), polyetheretherketone (PEEK), polysulfone (PSU), polyphenylsulfone (PPSU), polyphenylene sulfide (PPS), wherein the base polymer may also be configured as a compound, for example, which is a mixture of at least two of the above-mentioned polymers. A thermosetting tribopolymer may, for example, have phenolic resin as the base polymer. Due to the embodiment according to the invention, the rolling bearing may, in particularly preferred embodiments, be a lubricant-free rolling bearing, so that the rolling bodies are mounted in the guide without lubricant. Such a lubricant-free rolling bearing may be particularly low-maintenance and environmentally friendly and may also be particularly advantageous for use in critical environments, such as in the food industry.

Since the slide ring forms the guide portion of the bearing ring, the rolling bodies roll uninterruptedly on the slide ring and thus on the first plastics material during a complete revolution of the bearing rings relative to each other around the axis. In this way, the advantageously selectable properties of the first plastics material may ensure uninterrupted low friction between the rolling bodies and the bearing ring. The stabilising ring may ensure sufficient stability of the slide ring over the entire circumference by ensuring that the stabilising ring rests on the slide ring in a circumferential manner around the axis, in particular in an uninterrupted closed circumferential manner. Preferably, the stabilising ring extends over at least 50%, in particular over at least 80% of the axial extent of the slide ring, preferably over at least the entire axial extent of the slide ring, over its entire circumference around the axis. Preferably, the slide ring has, as two radial sides, a radial inner side and a radial outer side, each of which surrounds the axis in an uninterrupted closed manner, wherein one of these radial sides forms the guide portion and the stabilising ring rests on the other of these radial sides, in particular uninterruptedly over its entire circumferential course around the axis. In this way, the stabilising ring may be used to create a particularly effective stabilisation of the bearing ring for the application in the rolling bearing. It is particularly preferable for the rolling bodies to be in uninterrupted contact with the slide ring with a contact surface at least five times as large as that of the stabilising ring while the bearing rings rotate 360 degrees relative to each other around the axis. The contact surface with which the rolling bodies rest on the slide ring is therefore at least five times as large as the contact surface with which they rest on the stabilising ring. Preferably, the rolling bodies are not in contact with the stabilising ring. The stabilising ring is therefore preferably at a distance from the rolling bodies, in particular in every possible rotational position of the bearing rings about the axis relative to each other.

In a generally preferred embodiment, each of the bearing rings has a slide ring and a stabilising ring. The advantageous properties described above with reference to a bearing ring in various embodiments may then be provided for one or both of the bearing rings. Since both bearing rings, i.e., the inner ring and the outer ring, each have a slide ring and a stabilising ring as described above for various embodiments, the entire rolling bearing may be configured to be particularly simple, low-friction and at the same time robust. The slide ring of the inner ring particularly preferably surrounds the stabilising ring of the inner ring. Particularly preferably, the stabilising ring of the outer ring surrounds the slide ring of the outer ring. In this way, the slide rings of the inner and outer ring form the radially opposite guide portions of the guide in which the rolling bearings are guided.

Generally preferably, the first plastics material has a hardness with a Shore D value of less than 75, in particular less than 70, in particular less than 65, in particular less than 60. Preferably, the first plastics material has a hardness with a Shore D value in a range from 30 to 75, in particular 35 to 65, in particular 40 to 60. Generally particularly preferably, the second plastics material has a hardness with a Shore D value that is at least 5, in particular at least 10, in particular at least 15, in particular at least 20 greater than the Shore D value of the first plastics material. Generally preferably, the second plastics material has a hardness with a Shore D value that is at least 60, in particular at least 65, in particular at least 70, in particular at least 75. Preferably, the second plastics material has a hardness with a Shore D value in a range from 60 to 100, in particular 65 to 100, in particular 70 to 95, in particular 70 to 90. The inventors have found that by combining the first and second plastics material in such a way that the second plastics material is very hard but the first plastics material still has a considerable hardness, it is possible to produce a particularly robust and at the same time low-friction rolling bearing having the features of the invention. Generally preferably, a coefficient of friction between the rolling bodies and the first plastics material is lower than a coefficient of friction between the rolling bodies and the second plastics material. Generally preferably, the first plastics material comprises a higher proportion of lubricants than the second plastics material.

In one embodiment, only the first plastics material is configured as a sliding material; in another embodiment, the first and second plastics material are configured as a sliding material.

In one embodiment, the rolling bodies are rotatably mounted in a bearing cage surrounding the axis and are guided at a fixed angular distance from each other. The bearing cage is arranged radially between the guide portions of the inner ring and the outer ring. By providing a bearing cage that ensures a fixed angular distance between the rolling bodies when the bearing rings rotate relative to each other, the bearing characteristics of the rolling bearing may be particularly favourable. The bearing ring is preferably produced from a sliding material. The sliding material is a plastics material, which may be configured, for example, as explained above, in particular as a tribopolymer. Preferably, the sliding material from which the bearing cage is made differs from the first plastics material and/or from the second plastics material. It is generally preferred that the inner ring, the outer ring and the bearing cage are each produced from plastics material. As a result, the rolling bearing may be provided in a cost-effective and environmentally friendly manner, wherein the configuration of the inner ring, the outer ring and the bearing cage produced from plastics material may be particularly advantageous for the realisation of the rolling bearing as a lubricant-free rolling bearing.

In one embodiment, the rolling bodies are produced from a material that has a greater hardness than the first plastics material and, in particular, a greater hardness than the second plastics material. The rolling bodies are particularly preferably produced from glass, metal, a plastics material or a ceramic. In a particularly preferred embodiment, the rolling bodies are produced from glass, a plastics material or a ceramic. This may be particularly advantageous for the realisation of a lubricant-free rolling bearing.

In one embodiment, the slide ring and the stabilising ring rest on each other form-fittingly both in a direction along the axis and perpendicular to the axis, i.e., axially and radially. The form-fitting contact may ensure a particularly high stability of the bearing ring.

According to the invention, the stabilising ring and the slide ring each have projections distributed around the axis, wherein a recess is provided in each case between two adjacent projections. It is particularly preferable for the projections and, in particular, the recesses to be evenly distributed around the axis. One of the projections of the stabilising ring is arranged in each case in one of the recesses of the slide ring and one of the projections of the slide ring is arranged in each case in one of the recesses of the stabilising ring. The interlocking of projections and recesses of the stabilising ring and the slide ring may ensure a particularly dimensionally stable connection between the stabilising ring and the slide ring, in particular a particularly good form-fit connection. The recesses may, for example, be formed by reducing the thickness of the respective ring or by providing a recess in the respective ring running in one direction through the respective ring. Particularly preferably, the projections of the slide ring together extend over at least 30% of the axial length of extent of the slide ring. This means that at least 30% of the axial extent of the slide ring is formed by its projections. Accordingly, the projections and the recesses of the slide ring preferably extend over at least 30% of the axial length of extent of the slide ring, since the recesses are formed perpendicular to the axial direction between the projections. Preferably, the projections of the stabilising ring extend over at least 30% of the axial length of extent of the stabilising ring. This means that at least 30% of the axial extent of the stabilising ring is formed by its projections. Accordingly, the projections and the recesses, which are formed perpendicular to the axial direction between the projections, preferably extend over at least 30% of the axial length of extent of the stabilising ring. As the projections of the stabilising ring and/or the slide ring extend over at least 30% of its axial length of extent, a dimensionally stable connection between the stabilising ring and the slide ring may be ensured over a considerable axial extent. Particularly preferably, the projections and recesses are provided outside the axial extent of the rolling bodies over at least 50% of their axial length of extent, in particular at least 70% of their axial length of extent. This may minimise the influence of the interlocking of projections and recesses on the bearing of the rolling bodies.

In one embodiment, at least some of the projections of the stabilising ring and the slide ring are configured as radial projections and some of the recesses of the stabilising ring and the slide ring are configured as radial recesses, wherein one of the radial projections of the stabilising ring is arranged in each of the radial recesses of the slide ring and one of the radial projections of the slide ring is arranged in each of the radial recesses of the stabilising ring. The interlocking of radial projections and recesses may be particularly effective in preventing the stabilising ring and the slide ring from rotating relative to each other. In a particularly preferred embodiment, the radial projections of the slide ring are wider than the radial projections of the stabilising ring, which may be particularly advantageous for the stability of the bearing ring and thus of the stabilising ring and slide ring.

In one embodiment, at least some of the radial projections each have a width that increases along their radial extent into the radial receptacle assigned to them, forming an undercut. The associated radial receptacle is the receptacle in which the respective radial projection is arranged. As the radial projections widen along their radial extent into the radial receptacle assigned to them, they form an undercut that acts in the radial direction so that the radial projections are unable to move radially out of the assigned radial receptacle due to the undercut, which is particularly advantageous for the stability of the bearing ring.

In one embodiment, the stabilising ring and the slide ring each have a first group and a second group of projections, wherein the two groups of projections are provided at opposite axial ends of the stabilising ring or the slide ring. The rolling bodies are preferably arranged axially between the two groups of projections. The rolling bodies preferably extend with at least 50%, in particular at least 70% of their axial extent outside the axial area in which the projections are arranged. The projections of the first group are particularly preferably configured as axial projections and the projections of the second group as radial projections. Particularly preferably, a projection of the first group is arranged within the same angular range around the axis as an associated projection of the second group. By providing two groups of projections, the connection between the stabilising ring and the slide ring may be particularly favoured. As the projections of the two groups are each arranged in the same angular range, the ability of the stabilising ring and the slide ring to fit together and their stability may be particularly favoured.

In one embodiment, the slide ring has a greater length of extent in the radial direction averaged over its circumferential course around the axis than the stabilising ring. This is based on the length of extent in the radial direction, i.e., radial thickness, averaged over the entire circumferential course around the axis and averaged over the same axial portion, wherein the portion comprises at least 50% of the axial length of extent of the stabilising ring and the slide ring, in particular 100% of the axial length of extent of at least one of the stabilising ring and the slide ring. Preferably, the radial length of extent, i.e., radial thickness, is averaged over the entire circumferential course around the axis and over the entire axial length of extent of the stabilising ring and the slide ring in each case. The inventors have recognised that the provision of a sufficiently radially thick slide ring is particularly advantageous for a reliable and low-friction bearing or guidance of the rolling bodies, whereas in many applications a stabilising ring with a small thickness is already sufficient for adequate stability, since the stabilising ring is produced from a plastics material with high hardness.

In one embodiment, the guide portions engage behind the rolling bodies on both of their axial sides. The guide portions thus preferably form a groove in which the rolling bodies are guided. This has proven to be particularly advantageous when balls are used as rolling bodies. By engaging behind the rolling bodies on their two axial sides, the bearing rings and the rolling bodies may be guided in relation to each other by means of the rolling bodies. It is particularly preferable for the guide portions to each have a circular portion-shaped cross-section with which they surround the axis, so that their circular portion-shaped cross-section surrounding the axis forms a surface on which the rolling bodies may roll. This is particularly advantageous when balls are provided as rolling bodies. It is particularly preferable for the bearing rings to be fixed in their axial position relative to each other by the two guide portions engaging behind the rolling bodies on both axial sides.

In one embodiment, at least one of the guide portions adjoins an insertion portion with an insertion bevel at one of its axial ends. Particularly preferably, both guide portions adjoin an insertion portion with an insertion bevel at one of their axial ends, so that the insertion bevels of the insertion portions, which are surrounded by the respective bearing ring forming the respective guide portion, are radially opposite each other. The provision of such an insertion portion with an insertion bevel is particularly advantageous for the joining of the bearing rings and the rolling bodies. It is particularly preferable for the bearing ring with the guide portion to have an outer diameter that increases along the axis over the course of the insertion portion or an inner diameter that decreases along the axis over the course of the insertion portion. Preferably, the outer ring forms a guide portion that adjoins an insertion portion with an insertion bevel at one of its axial ends, wherein the outer ring has an inner diameter that decreases over the course of the insertion portion along the axis. The inner diameter decreases from an axial end of the outer ring towards the guide portion. Particularly preferably, the inner ring forms a guide portion which adjoins an insertion portion with an insertion bevel at one of its axial ends, wherein the inner ring has an outer diameter which increases along the axis over the course of the insertion portion, wherein the outer diameter increases from an axial end of the inner ring towards the guide portion. While the rolling bodies are in contact with the guide portion and not with the insertion portion in the intended operating state of the rolling bearing, the rolling bodies may be guided along the insertion portion to the guide portion when the rolling bearing comprising the inner ring, the outer ring and rolling bodies is assembled. The guide portion and the insertion portion are preferably each formed by the slide ring of the respective bearing ring.

In one embodiment, the slide ring and the stabilising ring are arranged pressed together in a radial interference fit. In one embodiment, the slide ring and the stabilising ring, in particular the bearing ring as a whole, are produced by injection moulding. In a particularly preferred embodiment, the slide ring and the stabilising ring are produced using a multi-component injection moulding process or one of the slide ring and the stabilising ring is injection moulded onto the other of the slide ring and the stabilising ring. When produced using a multi-component injection moulding process, the slide ring and the stabilising ring may be produced simultaneously, wherein a different plastics material is used for each of the two rings. When produced by injection moulding the slide ring onto the stabilising ring or the stabilising ring onto the slide ring, one of the slide ring and the stabilising ring is produced first and then the other is produced by injection moulding onto one of them.

In one embodiment, at least one of the bearing rings, in particular at least the inner ring, has a flange which extends radially along the rolling bodies and which covers the rolling bodies on one of their axial sides. The rolling bodies may be protected by such a flange, whereby the entry of particles causing friction or other damage may at least be reduced. The flange is particularly preferably formed by the stabilising ring. Particularly preferably, the flange is in sliding contact with the slide ring of the other bearing ring around the axis. As both bearing rings each have a slide ring and a stabilising ring and the stabilising ring, which forms the flange, rests on the slide ring of the other of the bearing rings, on the one hand the best possible sealing and thus the best possible protection of the rolling bodies or the guide with the rolling bodies arranged therein may be made possible due to the contact of the flange with the slide ring, and on the other hand friction between the bearing rings may be kept as low as possible as a result. Recesses distributed around the axis are particularly preferred in the flange, wherein either the flange is formed by the stabilising ring and the slide ring extends with a portion into the recesses or the flange is formed by the slide ring and the stabilising ring extends into the recesses. By extending the other ring into the recesses of the flange, it is particularly advantageous to ensure a dimensionally stable connection between the stabilising ring and the slide ring. Preferably, the respective ring (stabilising ring or slide ring that does not have the flange) extends into the recesses with its projections as described above.

In one embodiment, the inner ring has a projecting projection on its radially inner side and/or the outer ring has a projecting projection on its radially outer side for rotationally fixed engagement in a first component, which is rotatably mounted relative to a second component by the rolling bearing. The first component is rotationally fixed to the inner ring or the outer ring, wherein the projecting projection of the inner ring or the outer ring is arranged in a receptacle provided in the first component. The second component is rotationally fixed to the other inner ring or outer ring. Accordingly, the two components are rotatably mounted in relation to each other by the rolling bearing, wherein each of the inner ring and the outer ring are rotationally fixed to one of the two components. Preferably, one of the components is pressed with the inner ring in a manner surrounded thereby in a radial interference fit and the other of the components is pressed circumferentially in a radial interference fit externally around the outer ring.

In one embodiment, the inner ring has a receptacle on its radially inner side for receiving a shaft, wherein the receptacle has a diameter of at least 8 mm, in particular at least 1 cm, in particular at least 5 cm. Preferably, the outer ring has an outer diameter that is less than 4 cm, in particular less than 3 cm, in particular at least 1 cm larger than the diameter of the receptacle of the inner ring.

The invention further relates to a device comprising an outer component, in particular a frame part or gear part, an inner component, in particular a shaft or a further gear part, and a rolling bearing according to the invention. The inner ring is connected to the inner component and the outer ring is connected to the outer component for conjoint rotation, in particular by an interference fit. The components are rotatably connected to each other by the rolling bearing and, due to the properties of the rolling bearing according to the invention, are mounted so as to be rotatable relative to each other about the axis of the rolling bearing with as little friction as possible. The device is particularly preferably a bicycle. In one embodiment, the outer component is a bicycle frame, in particular a wheel fork of the bicycle frame, wherein the inner component is a wheel axle or a bottom bracket axle. In one embodiment, the outer component is a gear part of a bicycle transmission of the bicycle and the inner component is a further gear part of the bicycle transmission. For example, the bicycle transmission may be a bottom bracket transmission, wherein two gear parts of the bottom bracket transmission are mounted so as to be rotatable relative to each other by the rolling bearing. For example, the bottom bracket transmission may have several gears, in particular a sun gear, a ring gear and at least one planetary gear, as well as a web shaft with at least one rotation axis for the planetary gear, wherein at least one of said gear parts, i.e., for example the sun gear, the ring gear, the at least one planetary gear and/or the web shaft, is rotatably mounted on another of the gear parts by the rolling bearing.

The invention is explained in greater detail below with reference to eight figures on the basis of exemplary embodiments.

In the figures:

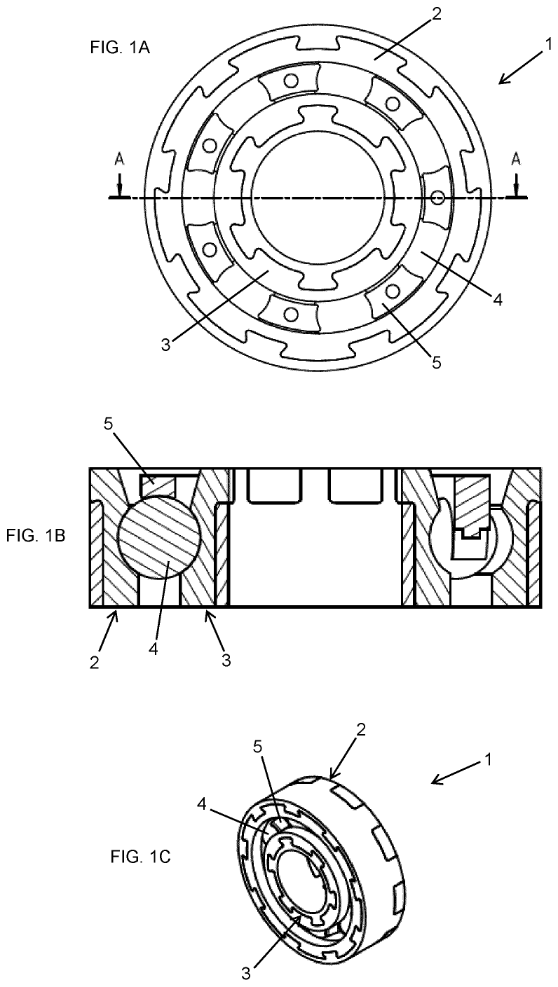

FIG. 1: shows various schematic basic representations of an embodiment of a rolling bearing according to the invention;

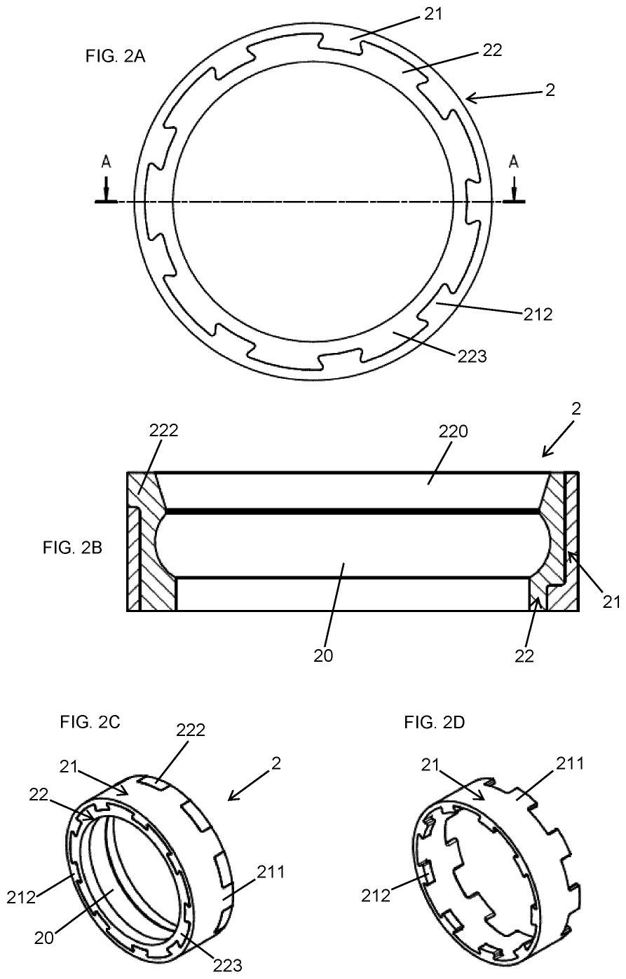

FIG. 2: shows various schematic basic representations of the outer ring of the rolling bearing according to FIG. 1;

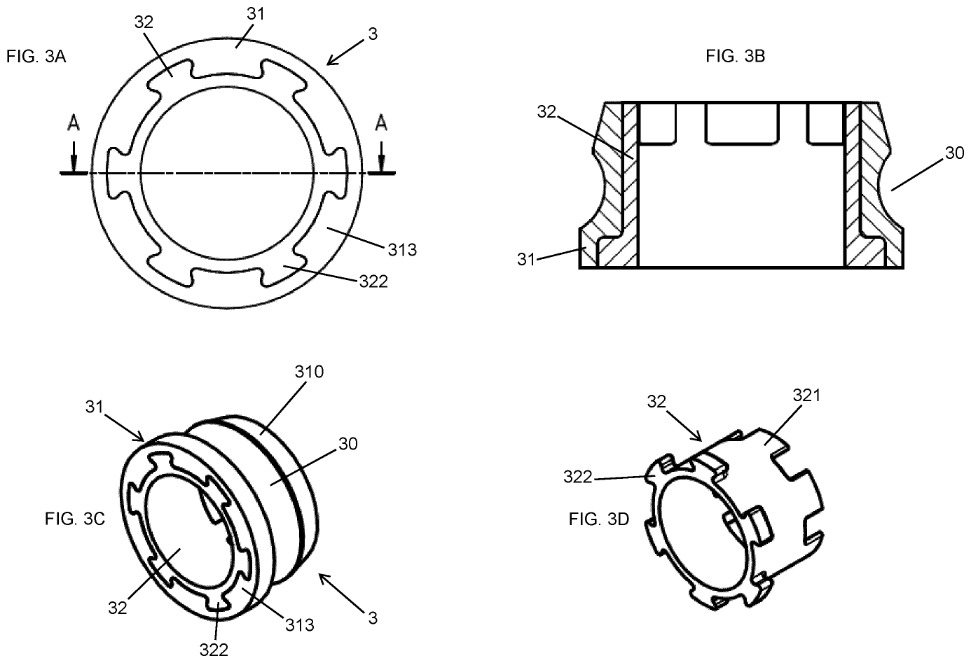

FIG. 3: shows various schematic basic representations of the inner ring of the rolling bearing according to FIG. 1;

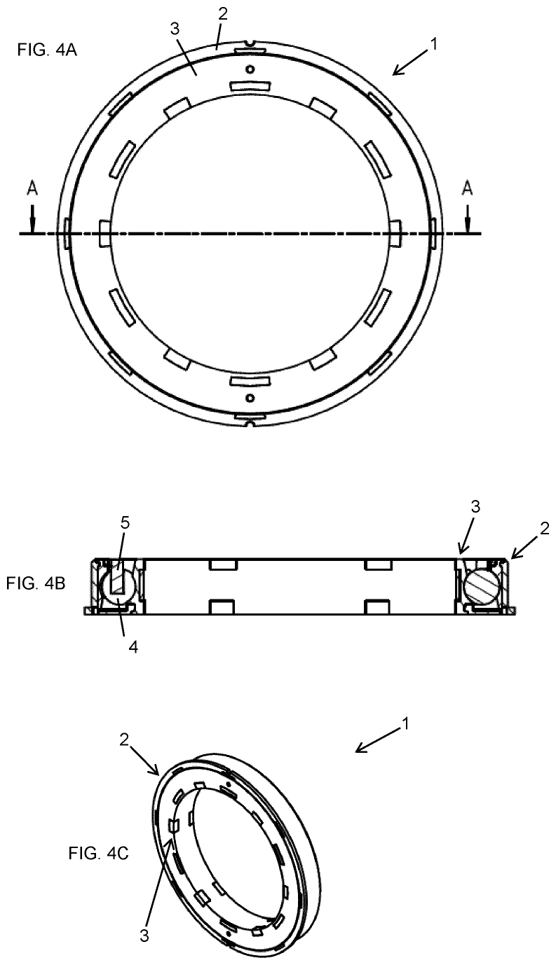

FIG. 4: shows various schematic basic representations of a further embodiment of the rolling bearing according to the invention;

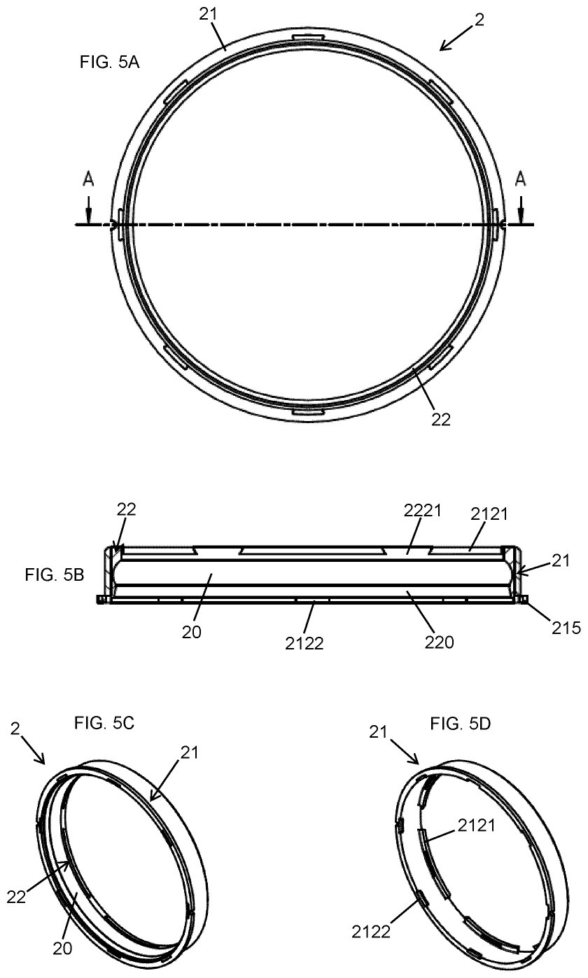

FIG. 5: shows various schematic basic representations of the outer ring of the rolling bearing according to FIG. 4;

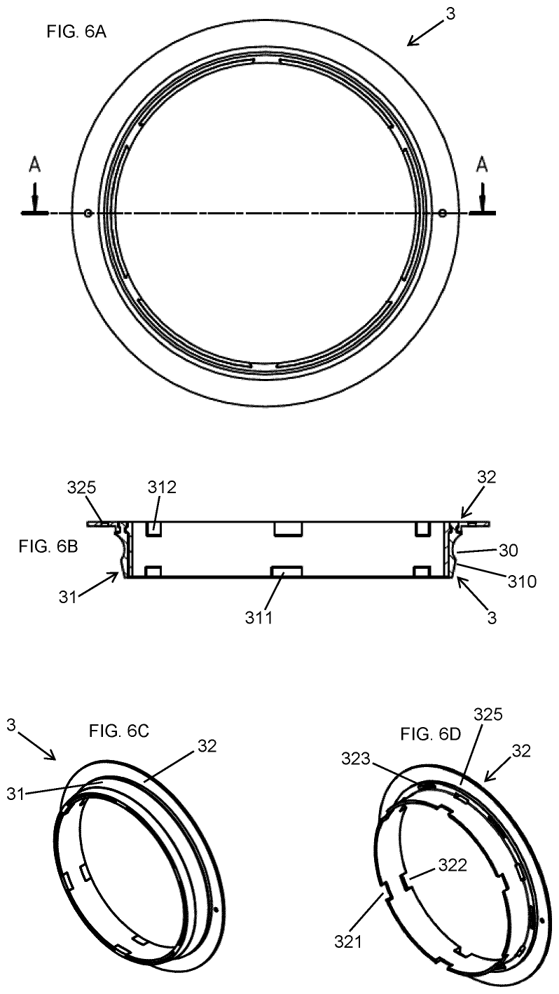

FIG. 6: shows various schematic basic representations of the inner ring of the rolling bearing according to FIG. 4;

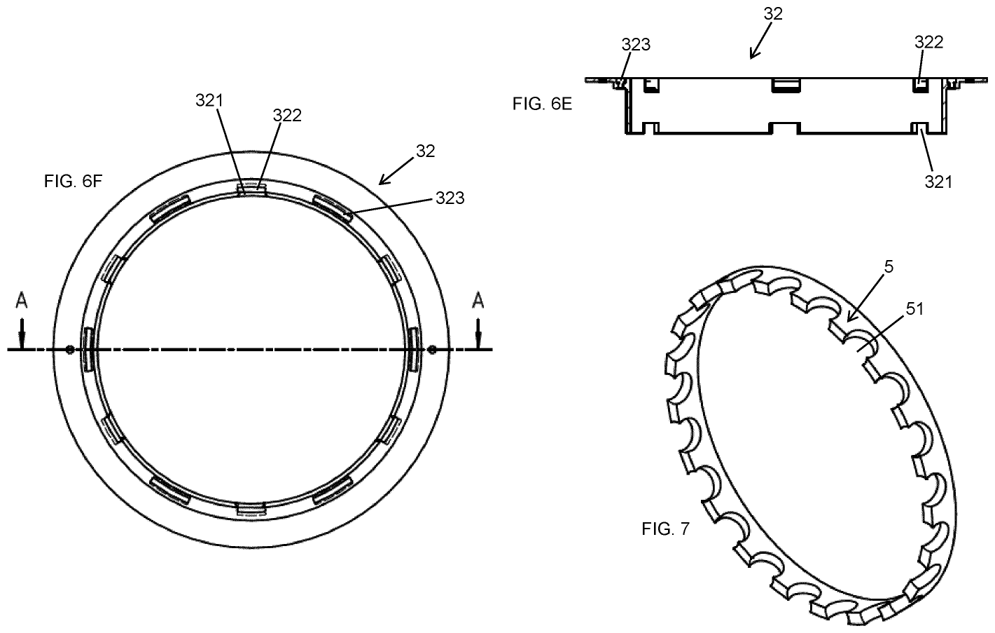

FIG. 7: shows a schematic basic representation of a bearing cage of an embodiment of the rolling bearing according to the invention;

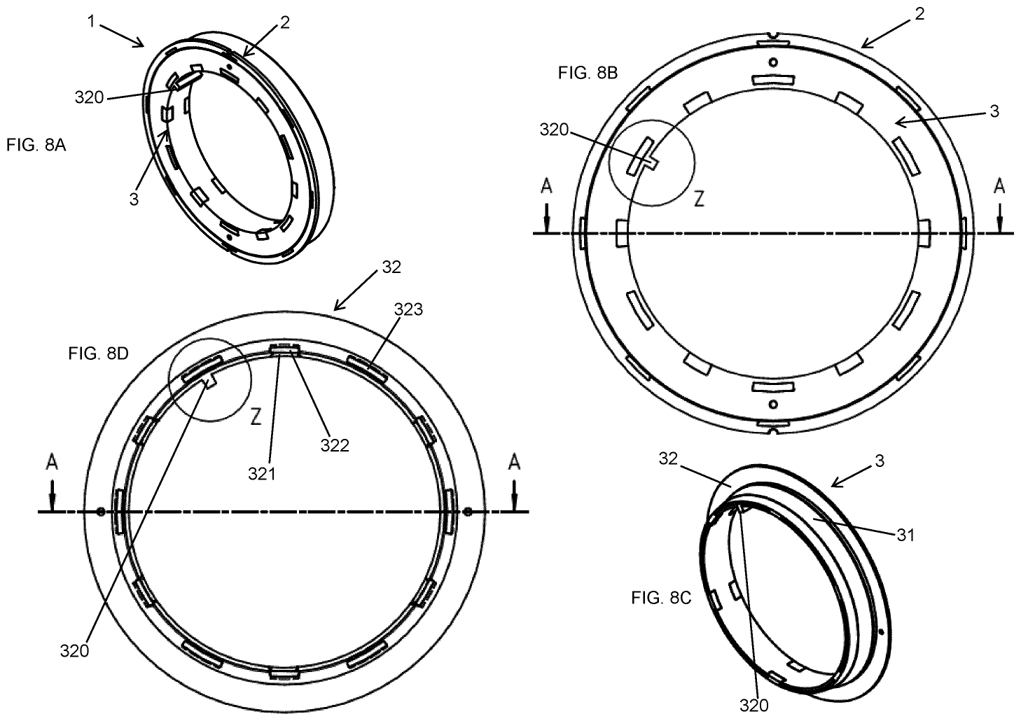

FIG. 8: shows various schematic basic representations of a further embodiment of a rolling bearing according to the invention.

In FIG. 1, comprising FIGS. 1A, 1B and 1C, an embodiment of a rolling bearing 1 according to the invention is shown schematically in various schematic representations. FIG. 1A shows a plan view of the rolling bearing 1 along the axial direction. FIG. 1B shows a cross-sectional view according to section A-A. FIG. 1C shows a perspective view. The rolling bearing 1 according to the embodiment shown in FIG. 1 has, as two bearing rings, an inner ring 3 and an outer ring 2. The inner ring 3 is arranged radially inside the outer ring 2. The two bearing rings each form a guide portion, wherein the guide portions together form a guide for rolling bodies 4, which are configured as balls in the present case. The guide portions of the inner ring 3 and the outer ring 2 face each other in a radial direction and are therefore opposite each other in a radial direction, as may be seen in particular in FIG. 1B. The rolling bodies 4 are held in contact with the guide portions between the inner ring 3 and the outer ring 2. Furthermore, the rolling bearing 1 has a bearing cage 5, which is arranged radially between the inner ring 3 and outer ring 2, enclosing the balls or rolling bodies 4 in portions, and ensures that the rolling bodies 4 or balls are positioned at a uniform angular distance from each other.

In FIG. 2, comprising FIGS. 2A, 2B, 2C and 2D, various views of the outer ring 2 or components of the outer ring 2 are shown schematically in various schematic representations. The outer ring 2 comprises a slide ring 22 and a stabilising ring 21. The slide ring 22 is produced from a sliding material, in this case a tribopolymer. The slide ring 22 preferably forms at least 50%, in particular at least 70%, in particular the predominant part, preferably the entire radial inner side of the outer ring 2, which is generally advantageous according to the invention. The slide ring 22 forms the guide portion 20 of the outer ring 2, wherein the guide portion engages behind the rolling bodies 4 on their two axial sides and has a circular portion-shaped cross-section. The cross-section is a cross-section perpendicular to its circumferential course around the axis. The guide portion 20 is also directly adjacent to an insertion portion 220. In this insertion portion, the slide ring 22 has an insertion bevel. Within this insertion bevel, the outer ring 2 has an inner diameter that decreases along the axis, starting from its axial end towards the guide portion 20. The guide portion 20 is suitable for reliably guiding the rolling bodies 4, which are configured as balls in the present case, whereas the insertion portion 220 is used for easy insertion of the balls into the guide portion 20 during assembly of the rolling bearing 1. The slide ring 22 and the stabilising ring 21 also have several projections 211, 212, 222, 223. One of the projections 211, 212 of the stabilising ring 21 is accommodated in each case in an associated recess in the slide ring 22, wherein the recess is formed between two adjacent projections 222, 223 of the slide ring 22. The term ‘adjacent projections’ means in each case an adjacency along the circumferential course around the axis. In particular, it may be seen from the combined view of FIGS. 2A and 2C that the stabilising ring 21 and the slide ring 22 each have radial projections 212, 223, wherein the radial projections 223 of the slide ring 22 are wider than the radial projections 212 of the stabilising ring 21, and wherein the radial projections 212, 223 each have a width that increases along their radial extent into the radial receptacle assigned to them in each case, forming an undercut. These undercuts are clearly recognisable in FIG. 2A. It may be seen that, due to these undercuts, a radial relative movement of the slide ring 22 and the stabilising ring 21 is effectively prevented. In the exemplary embodiment described, the stabilising ring 21 and the slide ring 22 each have two groups of projections. A first group of projections 222, 211 is provided at a first axial end of the respective ring, a second group of projections 212, 223 is provided at a second axial end of the respective ring. The guide portion 20 and the rolling bodies extend with their axial extent substantially outside the axial extent of the projections. Due to the interaction of the projections 211, 212, 222, 223, the slide ring and the stabilising ring are connected to each other in a radially and axially form-fitting manner. Approximately 30% of the axial length of extent of the rings is formed by the projections 211, 212, 222, 223.

In FIG. 3, comprising FIGS. 3A, 3B, 3C and 3D, the inner ring 3 or components of the inner ring 3 are shown in various views in schematic diagrams. The inner ring 3 has a stabilising ring 32 and a slide ring 31. The slide ring 31 surrounds the stabilising ring 32. The stabilising ring 32 forms a receptacle for receiving a shaft. Since the stabilising ring 32 is produced from a hard second plastics material, it is configured to fit onto a shaft with an interference fit. As explained for the outer ring 2 with reference to FIG. 2 above, the stabilising ring 32 and the slide ring 31 each have projections 313, 321, 322 which, as explained with reference to the outer ring 2 in FIG. 2, engage in each other, i.e., one of the projections engages in a recess that is formed between the projections of the other ring and that is assigned to it. The slide ring 31 preferably forms at least 50%, in particular at least 70%, in particular at least the predominant part, preferably the entire radial outer side of the inner ring 3, which is generally advantageous according to the invention. On this radial outer side, the slide ring 31 forms the guide portion 30 of the inner ring 3, which in the rolling bearing 1 lies radially opposite the guide portion 20 of the outer ring 2 and, analogously to the guide portion 20 of the outer ring 2, has a circular portion-shaped cross-section in which the rolling bodies 4, in this case balls, are held guided with an undercut acting in the axial direction. The slide ring 31 also forms an insertion portion 310 adjacent to the guide portion 30, in which the outer diameter of the inner ring 3 increases continuously from its axial end towards the guide portion 30, which is generally advantageous according to the invention. From the combined view of FIGS. 1-3 it may be seen that both the guide portions 20, 30 and the insertion portions 220, 310 are radially opposite each other, whereby both the assembly of the rolling bearing 1 and the guidance of the rolling bodies 4 in the assembled rolling bearing 1 are particularly favoured.

In FIG. 4, comprising FIGS. 4A, 4B and 4C, a further embodiment of a rolling bearing 1 according to the invention is shown schematically in various schematic representations. FIG. 4A shows a plan view along the axial direction. FIG. 4B shows a cross-section along section A-A. FIG. 4C shows a plan view of the rolling bearing 1. The rolling bearing 1 has an inner ring 3 and an outer ring 2. Rolling bodies 4 in the form of balls are arranged radially between the inner ring 3 and the outer ring 2 and are held at a constant angular distance from each other in a bearing cage 5. With reference to comparable parts of the rolling bearing 1 according to FIG. 4, reference is made to the explanations of the rolling bearing 1 according to FIGS. 1-3. In the following, only the differences between the rolling bearing according to FIG. 4 and the aforementioned rolling bearing 1 are discussed. FIGS. 4-6 are summarised, each of which relates to the rolling bearing shown in FIG. 5. In FIG. 5, comprising FIGS. 5A, 5B, 5C and 5D, the outer ring 2 or components of the outer ring 2 are shown schematically in various views in schematic diagrams. In FIG. 6, comprising FIGS. 6A, 6B, 6C, 6D, 6E and 6F, the inner ring 3 or components of the inner ring 3 are shown schematically in various views in schematic diagrams.

The outer ring 2 has a slide ring 22, which forms the guide portion 20 of the outer ring 2, and a stabilising ring 21, which completely surrounds the slide ring 22, which is generally advantageous according to the invention. The slide ring 22 forms the entire radially inner side of the outer ring 2, the stabilising ring 21 forms the entire radially outer side of the outer ring 2. The stabilising ring 21 forms a flange 215. This flange 215 is configured to project radially. This flange 215 is particularly advantageous as a stop when mounting the rolling bearing 1 with its outer ring 2 in an interference fit in an external component of a device. The inner ring 3 also has a stabilising ring 32 and a slide ring 31. The slide ring 31 completely surrounds the stabilising ring 32 and forms the majority of the radial outer side of the inner ring 3, which is generally advantageous according to the invention. Accordingly, it is generally advantageous according to the invention that the slide ring 22 of the outer ring 2 forms the predominant part of the radial inner side of the outer ring 2. The slide ring 31 of the inner ring 3 and the slide ring 22 of the outer ring 2 form the guide portion 30, 20 of the inner ring 3 and the outer ring 2 respectively, each of which adjoins an insertion portion 310, 220. The guide portions 20, 30 and insertion portions 220, 310 lie radially opposite each other. The stabilising ring 32 of the inner ring 3 forms a radially projecting flange 325. In particular, it may be seen from the combined view of FIGS. 4-6 that this flange 315 radially covers the rolling bodies 4 on one of their axial sides. The flange 325 rests on the slide ring 22 of the outer ring 2 in sliding contact, which ensures low friction on the one hand and reliable protection of the rolling bodies 4 on the other. Recesses 323 are provided in the flange 325, through which the slide ring 30 of the inner ring 3 extends. This ensures a particularly good form fit between the slide ring 31 and the stabilising ring 32 of the inner ring 3. In addition, the stabilising ring 32 has a group of projections at each of its two axial ends, wherein in each case two adjacent projections form a recess 321, 322 between them. A projection 311, 312 formed by the slide ring 31 is arranged in each of these recesses 321, 322. Accordingly, the slide ring 22 and the stabilising ring 21 of the outer ring have interlocking projections 2121, 2122, 2221.

FIG. 7 shows a bearing cage 5 of an embodiment of the rolling bearing 1 according to the invention in a schematic representation. The bearing cage 5 is configured, which is generally advantageous according to the invention, as a closed ring surrounding the axis, which has a plurality of rolling element receptacles 51, which are each spaced apart from each other at the same angular distance in relation to a rotation about the axis. These rolling element receptacles 51 are configured to accommodate rolling bodies 4 in the form of balls in such a way that they surround them over more than half of their circumference, which is generally advantageous according to the invention. This ensures particularly good fixing of the balls to each other by means of the bearing cage 5.

In FIG. 8, comprising FIGS. 8A, 8B, 8C and 8D, a further embodiment of a rolling bearing according to the invention or of components of the rolling bearing according to the invention is shown schematically in various views in schematic diagrams. In the following, only the differences compared to the exemplary embodiment shown in FIGS. 4-6 will be discussed. The rolling bearing 1 according to FIG. 8 has an outer ring 2 and an inner ring 3, which are configured largely analogously to the outer ring 2 and inner ring 3 of the exemplary embodiment according to FIGS. 4-6. However, the stabilising ring 32 of the inner ring 3 has a radially projecting projection 320 on its radially inner side. This radially projecting projection 320 extends generally advantageously over at least 50% of the axial length of extent of the inner ring 3, in the present case over its entire axial length of extent. Since the projecting projection 320 is formed by the stabilising ring 32 and projects radially inwards from the inner side thereof, the projecting projection 320 may be particularly advantageously suitable for a rotationally fixed mounting of the inner ring 3 of the rolling bearing 1 on an inner component of a device which has a receptacle corresponding to the projecting projection 320.

### LIST OF REFERENCE SIGNS

1 rolling bearing
2 outer ring
3 inner ring
4 rolling body
5 bearing cage
20 guide portion
21 stabilising ring
22 slide ring
30 guide portion
31 slide ring
32 stabilising ring
220 insertion portion
211 projection
212 projection
215 flange
222 projection
223 projection
310 insertion portion
311 projection
312 projection
313 projection
321 projection
322 projection
323 projection
325 flange
2121 projection
2122 projection
2222 projection

1. A rolling bearing comprising an inner ring and an outer ring which each form a guide portion of a guide provided between the bearing rings, which guide portion surrounds the axis, wherein the inner ring and the outer ring are mounted so as to be rotatable relative to each other about an axis, wherein the guide portion formed by the inner ring is radially opposite the guide portion formed by the outer ring, and, in the guide, rolling bodies are distributed around the axis and rest on the two guide portions so that when the bearing rings rotate relative to each other about the axis, the rolling bodies roll on the two guide portions, wherein at least one of the inner and outer rings has a slide ring, which forms the guide portion, and a stabilising ring, which rests on the slide ring so as to surround the axis, wherein the slide ring is produced from a first plastics material and the stabilising ring is produced from a second plastics material, wherein the first plastics material is softer than the second plastics material, wherein in particular the rolling bodies are mounted in the guide without lubricant, and in that the stabilising ring and the slide ring each have projections distributed around the axis, wherein a recess is provided in each case between two adjacent projections, wherein one of the projections of the stabilising ring is arranged in respectively one of the recesses of the slide ring and one of the projections of the slide ring is arranged in respectively one of the recesses of the stabilising ring.

2. The rolling bearing according to claim 1, wherein each of the inner and outer rings has a slide ring and a stabilising ring, wherein the slide ring of the inner ring surrounds the stabilising ring of the inner ring, and wherein the stabilising ring of the outer ring surrounds the slide ring of the outer ring.

3. The rolling bearing according to claim 1, wherein the rolling bodies contact the slide ring with a contact surface at least five times as large as that of the stabilising ring, wherein the stabilising ring is spaced apart from the rolling bodies.

4. The rolling bearing according to claim 1, wherein the first plastics material has a hardness with a Shore D value of less than 75, and wherein the second plastics material has a hardness with a Shore D value which is at least 5 greater than the Shore D value of the first plastics material.

5. The rolling bearing according to claim 1, wherein the first plastics material is a sliding material.

6. The rolling bearing according to claim 1, wherein
a coefficient of friction between the rolling bodies and the first plastics material is lower than a coefficient of friction between the rolling bodies and the second plastics material,
and/or
the first plastics material contains a higher proportion of lubricants than the second plastics material.

7. The rolling bearing according to claim 1, wherein the rolling bodies are rotatably mounted in a bearing cage surrounding the axis and are guided at a fixed angular distance from each other, wherein the bearing cage is arranged radially between the guide portions of the inner ring and the outer ring and is made of a sliding material, wherein the inner ring, the outer ring and the bearing cage are each produced from plastics material.

8. The rolling bearing according to claim 1, wherein the rolling bodies are produced from a material that has a greater hardness than the first plastics material, wherein the rolling bodies are produced from glass, metal, a plastics material or a ceramic.

9. The rolling bearing according to claim 1, wherein the slide ring and the stabilising ring rest on each other form-fittingly both in a direction along the axis and perpendicular to the axis.

10. The rolling bearing according to claim 1, wherein the projections of the slide ring extend over at least 30% of the axial length of extent of the slide ring and the projections of the stabilising ring extend over at least 30% of the axial length of extent of the stabilising ring.

11. The rolling bearing according to claim 1, wherein at least some of the projections of the stabilising ring and slide ring are configured as radial projections and some of the recesses are configured as radial recesses, wherein one of the radial projections of the stabilising ring is arranged in each of the radial recesses of the slide ring and one of the radial projections of the slide ring is arranged in each of the radial recesses of the stabilising ring, wherein the radial projections of the slide ring are wider than the radial projections of the stabilising ring.

12. The rolling bearing according to claim 11, wherein at least some of the radial projections each have a width that increases along their radial extent into the radial receptacle assigned to them to form an undercut.

13. The rolling bearing according to claim 10, wherein the stabilising ring and the slide ring each have a first group and a second group of projections, wherein the two groups of projections are provided at opposite axial ends of the stabilising ring or the slide ring and the rolling bodies are arranged axially between the two groups of projections and/or the projections of the first group are configured as axial projections and the projections of the second group are configured as radial projections, wherein in each case a projection of the first group is arranged within the same angular range about the axis as an associated projection of the second group.

14. The rolling bearing according to claim 1, wherein the slide ring has a greater length of extent in the radial direction averaged over a circumferential course around the axis than the stabilising ring.

15. The rolling bearing according to claim 1, wherein the guide portions each engage behind the rolling bodies on their two axial sides, wherein in particular the guide portions each have a circular portion-shaped cross-section with which they surround around the axis, wherein the bearing rings are fixed in their axial position relative to each other by the two guide portions engaging behind the rolling bodies on both axial sides.

16. The rolling bearing according to claim 1, wherein at least one of the guide portions adjoins an insertion portion with an insertion bevel at one of its axial ends, wherein the bearing ring having this guide portion has an outer diameter which increases along the axis over the course of the insertion portion or an inner diameter which decreases along the axis over the course of the insertion portion.

17. The rolling bearing according to claim 1, wherein the slide ring and the stabilising ring are arranged pressed together in a radial interference fit and/or are produced by injection moulding, wherein the slide ring and the stabilising ring are produced by multi-component injection moulding and/or one of the slide ring and the stabilising ring is moulded onto the other of the slide ring and the stabilising ring.

18. The rolling bearing according to claim 1, wherein the inner ring, has a flange which extends radially along the rolling bodies and which covers the rolling bodies on one of their axial sides, wherein the flange is formed by the stabilising ring and the flange rests on the slide ring of the outer bearing rings in sliding contact around the axis.

19. The rolling bearing according to claim 18, wherein recesses distributed around the axis are provided in the flange, wherein either the flange is formed by the stabilising ring and the slide ring extends with a portion into the recesses or the flange is formed by the slide ring and the stabilising ring extends into the recesses.

20. The rolling bearing according to claim 1, wherein the inner ring has a projecting projection on its radially inner side and/or the outer ring has a projecting projection on its radially outer side for rotationally fixed engagement in a first component, which is rotatably mounted relative to a second component by the rolling bearing.

21. The rolling bearing according to claim 1, wherein the inner ring has a receptacle on its radially inner side for receiving a shaft, wherein the receptacle has a diameter of at least 1 cm, wherein the outer ring has an outer diameter which is less than 4 cm greater than the diameter of the receptacle of the inner ring.

22. A device comprising an outer component, an inner component, and a rolling bearing according to claim 1,
wherein the inner ring is connected to the inner component and the outer ring is connected to the outer component for conjoint rotation, and the components are rotatably connected to each other by the rolling bearing,
wherein the device is a bicycle, the outer component is a bicycle frame or a gear part of a bicycle transmission of the bicycle, and the inner component is a wheel axle, a bottom bracket axle or a further gear part of the bicycle transmission.
